(19) United States
(12) Patent Application Publication
(10) Pub. No.: US 2015/0214814 A1
(43) Pub. Date: Jul. 30, 2015

(54) SPINDLE MOTOR AND HARD DISK DRIVE INCLUDING THE SAME

(71) Applicant: SAMSUNG ELECTRO-MECHANICS CO., LTD., Suwon-si (KR)

(72) Inventor: Duck Young KIM, Suwon-si (KR)

(73) Assignee: SAMSUNG ELECTRO-MECHANICS CO., LTD., Suwon-si (KR)

(21) Appl. No.: 14/586,173

(22) Filed: Dec. 30, 2014

(30) Foreign Application Priority Data
Jan. 29, 2014 (KR) 10-2014-0011271

(51) Int. Cl. H02K 7/08; G11B 19/20

(52) U.S. Cl. CPC H02K 7/086; G11B 19/2036

(57) ABSTRACT

There are provided a spindle motor and a hard disk drive including the same. The spindle motor includes: a lower thrust member fixedly attached to a base member; a shaft having a lower end portion coupled to the lower thrust member and an upper end portion provided with a flange part; a rotating member including a sleeve rotatably provided based on the shaft and a rotor hub extended from the sleeve in an outer radial direction; and a sealing member provided at an end portion of the flange part, extended in a downward axial direction so as to enclose an outer portion of an upper end of the sleeve, and forming a liquid-vapor interface between the sealing member and the sleeve, wherein the sealing member has a first inclined surface inclined in an inner radial direction and downwardly in the axial direction.

### CROSS-REFERENCE TO RELATED APPLICATION

This application claims the benefit of Korean Patent Application No. 10-2014-0011271 filed on Jan. 29, 2014, with the Korean Intellectual Property Office, the disclosure of which is incorporated herein by reference.

### BACKGROUND

The present disclosure relates to a spindle motor and a hard disk drive including the same.

In general, a small spindle motor used in a hard disk drive (HDD) is provided with a fluid dynamic bearing assembly, and a lubricating fluid such as oil is filled in a bearing clearance formed between a shaft and a sleeve of the fluid dynamic bearing assembly. The oil filled in the bearing clearance generates fluid dynamic pressure while being compressed, thereby rotatably supporting the shaft.

In addition, the bearing clearance is also formed by an upper surface of the sleeve and a lower surface of a rotor case coupled to the shaft to rotate together with the shaft. In addition, the bearing clearance formed by the upper surface of the sleeve and the lower surface of the rotor case is also filled with the lubricating fluid.

Meanwhile, when an external impact occurs, the lubricating fluid may be leaked from the above-mentioned bearing clearance, that is, from a side at which an interface between the lubricating fluid and air is formed to the outside of the bearing clearance.

In the case in which the lubricating fluid is leaked to the outside as described above, fluid dynamic pressure generated by the lubricating fluid may be deteriorated by a lack of a filled amount of the lubricating fluid. As a result, performance of the spindle motor may be deteriorated, and a lifespan thereof may be shortened.

Further, in the case in which the lubricating fluid is evaporated due to long-term use, the filled amount of the lubricating fluid may be insufficient.

As a result, a structure capable of suppressing evaporation of the lubricating fluid simultaneously with preventing leakage of the lubricating fluid should be urgently developed.

### RELATED ART DOCUMENT

(Patent Document 1) Japanese Patent Laid-Open Publication No. 2007-182946

### SUMMARY

An aspect of the present disclosure may provide a spindle motor capable of suppressing evaporation of a lubricating fluid simultaneously with preventing leakage of the lubricating fluid.

An aspect of the present disclosure may also provide a spindle motor having a structure capable of confirming a filled amount of a fluid as accurately as possible during a process of filling a lubricating fluid.

According to an aspect of the present disclosure, a spindle motor may include: a lower thrust member fixedly attached to a base member; a shaft having a lower end portion coupled to the lower thrust member and an upper end portion provided with a flange part; a rotating member including a sleeve rotatably provided based on the shaft and a rotor hub extended from the sleeve in an outer radial direction; and a sealing member provided at an end portion of the flange part, extended in a downward axial direction so as to enclose an outer portion of an upper end of the sleeve, and forming a liquid-vapor interface between the sealing member and the sleeve, wherein the sealing member has a first inclined surface inclined in an inner radial direction and downwardly in the axial direction.

The rotor hub may have a second inclined surface inclined so that a gap between the first inclined surface of the sealing member and a surface facing the first inclined surface is decreased inwardly in the radial direction.

The second inclined surface may be inclined so that a lowermost end portion of the sealing member is visible when viewing a gap between the sealing member and the rotor hub from the outside.

The spindle motor may further include a cap member covering a gap formed by the sealing member and the rotor hub.

The cap member may include a fixed part having an end portion fixed to an upper surface of the rotor hub, a cover part extended from the fixed part inwardly in the radial direction and bent toward an upper portion of the sealing member, and an extension part extended from an inner end of the cover part in a radial direction to the upper portion of the sealing member.

The rotor hub may include a seating step part on which the fixed part is seated.

The sealing member may include a sealing disposal part stepped so that an end portion of the extension part is disposed thereon.

A portion of the sleeve facing the sealing member may include a portion inclined inwardly in the radial direction and downwardly in the axial direction.

A portion of the sealing member facing the sleeve may include a portion inclined in the outer radial direction and downwardly in the axial direction.

According to another aspect of the present disclosure, a hard disk drive may include: the spindle motor as described above, rotating a disk by power applied thereto through a substrate; a magnetic read-write head writing data to and reading data from the disk; and a head transfer part transferring the magnetic read-write head to a predetermined position on the disk.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view illustrating a spindle motor according to an exemplary embodiment of the present disclosure;

FIG. 2 is an enlarged view illustrating an example of part A of FIG. 1;

FIG. 3, which is an enlarged view of part B of FIG. 2, is a reference view for describing a process of confirming a filled amount of a lubricating fluid; and

FIG. 4 is a schematic cross-sectional view illustrating a hard disk drive in which the spindle motor according to an exemplary embodiment of the present disclosure is mounted.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements .

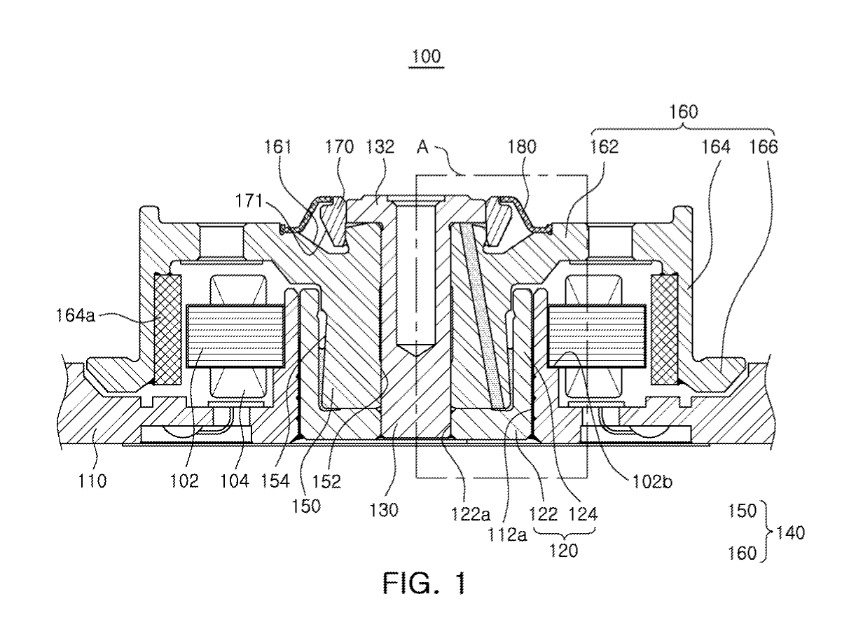

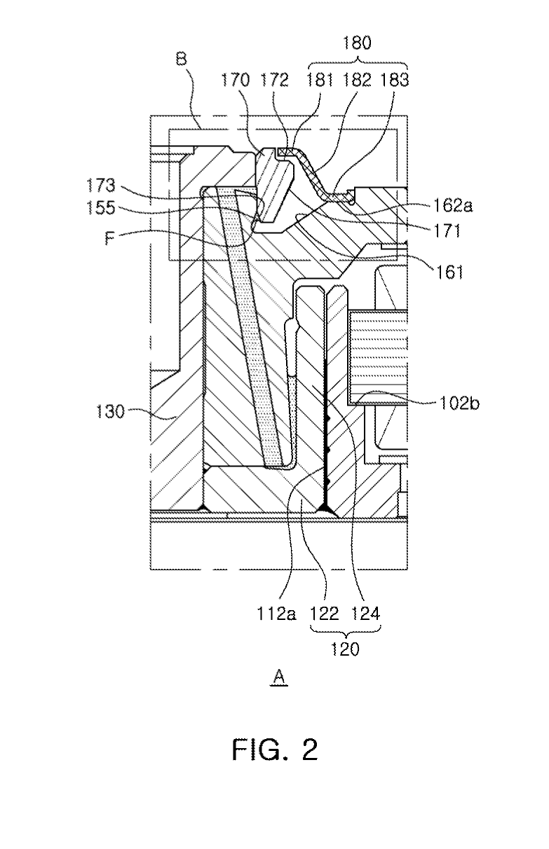

FIG. 1 is a schematic cross-sectional view illustrating a spindle motor according to an exemplary embodiment of the present disclosure, and FIG. 2 is an enlarged view illustrating an example of part A of FIG. 1.

Referring to FIGS. 1 and 2, a spindle motor 100 according to an exemplary embodiment of the present disclosure may include, for example, a base member 110, a lower thrust member 120, a shaft 130, a rotating member 140, a sealing member 170, a cap member 180, and a fixed member 190.

Meanwhile, the spindle motor 100 according to an exemplary embodiment of the present disclosure may be a motor used in a hard disk drive driving a recording disk.

The rotating member 140 may rotate based on the shaft 130. In addition, an installation groove 142 into which a flange part 132 of the shaft 130 is insertedly disposed may be formed in the rotating member 140. The flange part 132 and the sealing member 170 as described above may be insertedly disposed in the installation groove 142. Further, an installation protrusion 144 for installing the cap member 180 may be provided on the rotating member 140.

Meanwhile, the rotating member 140 may include a sleeve 150 forming a bearing clearance together with the lower thrust member 120 and the shaft 130 and a rotor hub 160 extended from the sleeve 150.

The sleeve 150 may be rotatably mounted on the shaft 130.

The sleeve 150 may be disposed between the flange part 132 of the shaft 130 and a disk part 122 of the lower thrust member 120 and form the bearing clearance together with the shaft 130 and the lower thrust member 120.

Meanwhile, the sleeve 150 may include a shaft hole 152 formed therein, wherein the shaft hole 152 has the shaft 130 penetrating therethrough. That is, the rotating member 140 may rotate based on the shaft 130 insertedly disposed in the shaft hole 152 of the sleeve 150.

In addition, upper and lower radial dynamic pressure grooves (not shown) may be formed in at least one of an inner peripheral surface of the sleeve 150 or an outer peripheral surface of the shaft 130. The upper and lower radial dynamic pressure grooves may be disposed to be spaced apart from each other in an axial direction by a predetermined interval, and generate fluid dynamic pressure in a radial direction at the time of rotation of the sleeve 150.

Therefore, the rotating member 140 may more stably rotate.

Meanwhile, an inclined surface 154 for forming a liquid-vapor interface together with a sealing wall part 124 of the lower thrust member 120 may be formed at a lower end portion of an outer peripheral surface of the sleeve 150. Therefore, an interface between the lubricating fluid and the air may be formed in a space formed by the inclined surface 154 and an inner peripheral surface of the sealing wall part 124 due to a capillary phenomenon.

In addition, a fourth inclined surface may be provided at an upper end portion of an outer surface of the sleeve 150 so as to easily form a liquid-vapor interface F between the sleeve 150 and the sealing member 170. Alternatively, a third inclined surface 173 may be provided at an inner surface of the sealing member 170 corresponding to the upper end portion of the outer surface of the sleeve 150.

The rotor hub 160 may be extended from the sleeve 150. Meanwhile, although the case in which the rotor hub 160 and the sleeve 150 are formed integrally with each other is described in the present exemplary embodiment by way of example, the present disclosure is not limited thereto. The rotor hub 160 and the sleeve 150 maybe separately manufactured and assembled with each other.

Meanwhile, the rotor hub 160 may include a body 162 having a disk shape, a magnet mounting part 164 extended from an edge of the body 162 in a downward axial direction, and a disk supporting part 166 extended from a distal end of the magnet mounting part 164 in the radial direction.

In addition, the magnet mounting part 164 may include a driving magnet 164a fixedly attached to an inner surface thereof. Therefore, an inner surface of the driving magnet 164a may be disposed to face a front end of a stator core 102.

Meanwhile, the driving magnet 164a may be a permanent magnet generating magnetic force having a predetermined strength by alternately magnetizing an N pole and an S pole thereof in the circumferential direction.

Here, a rotational driving scheme of the rotating member 140 will be simply described. When power is applied to a coil 104 wound around the stator core 102, driving force rotating the rotating member 140 may be generated by electromagnetic interaction between the stator core 102 including the coil 104 wound therearound and the driving magnet 164a, thereby rotating the rotating member 140.

That is, the rotating member 140 may be rotated by the electromagnetic interaction between the driving magnet 164a and the stator core 102 including the coil 104 wound therearound and disposed to face the driving magnet 164a.

The sealing member 170 may be fixedly attached to the flange part 132 of the shaft 130. That is, an inner peripheral surface of the sealing member 170 may be bonded to an outer peripheral surface of the flange part 132. Meanwhile, an inclined surface 172 for forming a liquid-vapor interface may be formed at the sealing member 170. As an example, the liquid-vapor interface may be formed in a space formed by an outer peripheral surface of the sealing member 170 and a side wall part forming the installation groove 142 of the rotating member 140. To this end, the inclined surface 172 maybe formed at the outer peripheral surface of the sealing member 170. In addition, the sealing member 170 may be extended in the downward axial direction so as to enclose an outer portion of an upper end of the sleeve 150, thereby forming the liquid-vapor interface F between the sealing member 170 and the sleeve 150.

Meanwhile, the sealing member 170 may have a circular ring shape.

The cap member 180 may be fixedly attached to the rotating member 140 and serve to prevent leakage of the lubricating fluid. Meanwhile, the cap member 180 may have a bent shape. As an example, the cap member 180 may be installed by the bonding between a portion thereof extended in the axial direction and the installation protrusion 144 formed at the rotating member 140. In addition, the cap member 180 may be fixedly attached to the rotating member 140 by any one of an adhesion scheme and a welding scheme.

The cap member 180 may include a fixed part 183 having an end portion fixed to an upper surface of the rotor hub 183, a cover part 182 extended from the fixed part in an inner radial direction and bent toward an upper portion of the sealing member 170, and an extension part 181 extended from an inner end of the cover part in the radial direction to the upper portion of the sealing member 170.

In addition, a seating step part 162a on which the fixed part 183 is seated may be provided at the rotor hub 160.

Further, the sealing member 170 may include a sealing disposal part 172 stepped so that an end portion of the extension part 181 is disposed thereon.

Meanwhile, in the spindle motor 100 according to an exemplary embodiment of the present disclosure, the liquid-vapor interface F of the lubricating fluid may be formed between an outer surface of the sleeve 150 and an inner surface of the sealing member 170 in the radial direction. In addition, the liquid-vapor interface may be directed in the downward axial direction. Therefore, as shown in FIGS. 1 through 3, substantially, it is significantly difficult to confirm whether or not the lubricating fluid is accurately filled in the desired liquid-vapor interface F during a process of filling the lubricating fluid in a fluid dynamic bearing assembly. The reason is that the spindle motor has a structure in which the liquid-vapor interface F may not be confirmed from the outside.

Therefore, the present exemplary embodiment provides a structure of the spindle motor 100 capable of preventing the lubricating fluid from being excessively filled by enabling confirmation of the vicinity of the liquid-vapor interface F as close as possible from the outside even though the liquid-vapor interface F may not be substantially confirmed.

In order to provide this structure, in the present exemplary embodiment, an outer surface of the sealing member 170 in the radial direction may be provided as a first inclined surface 171 inclined inwardly in the radial direction and downwardly in the axial direction.

In addition, the rotor hub 160 may have a second inclined surface 161 inclined so that a gap between the first inclined surface 171 of the sealing member 170 and a surface facing the first inclined surface 171 is decreased inwardly in the radial direction. Further, the second inclined surface 161 may be inclined so that a lowermost end portion of the sealing member 170 is visible when viewing a gap between the sealing member 170 and the rotor hub 160 from the outside.

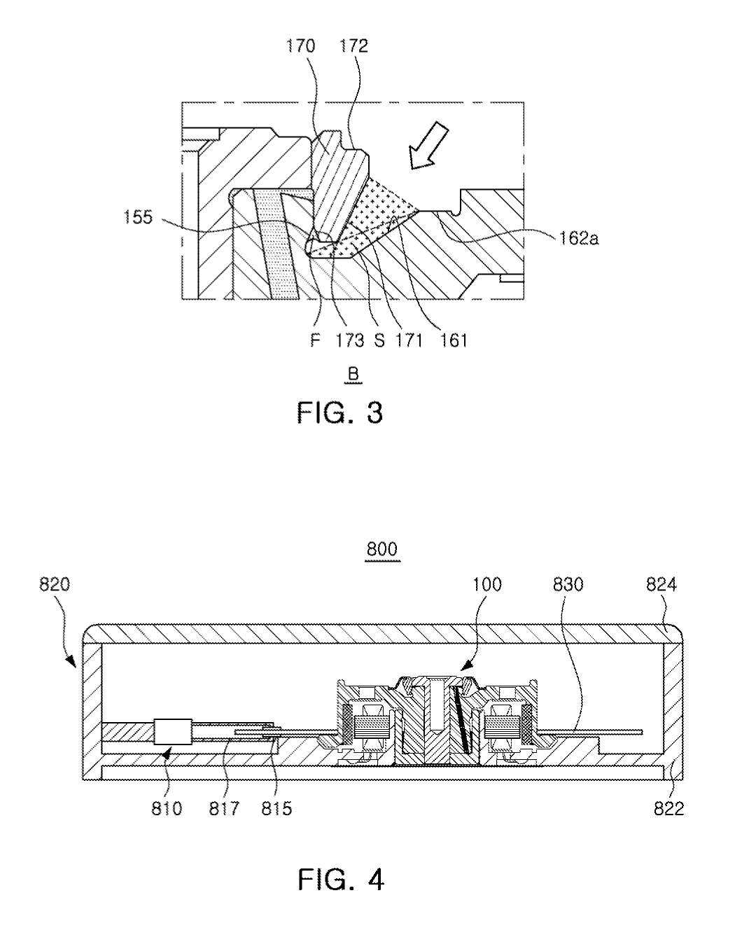

In the case in which the spindle motor has the structure as described above, during the process of filling the lubricating fluid, even a portion significantly close to the liquid-vapor interface F may be visibly confirmed. That is, as shown in FIG. 3, since a visible portion S is significantly widely formed, whether or not the lubricating fluid is excessively filled may be substantially confirmed.

Referring to FIG. 4, a recording disk driving device 800 including the spindle motor 100 according to an exemplary embodiment of the present disclosure mounted therein may be a hard disk drive and include the spindle motor 100, a head transfer part 810, and a housing 820.

The spindle motor 100 has all the characteristics of the motor according to the present disclosure described above and may have a recording disk 830 mounted thereon.

The head transfer part 810 may transfer a magnetic read-write head 815 detecting information of the recording disk 830 mounted in the spindle motor 100 to a surface of the recording disk of which the information is to be detected.

Here, the magnetic read-write head 815 may be disposed on a support part 817 of the head transfer part 810.

The housing 820 may include a motor mounting plate 822 and a top cover 824 shielding an upper portion of the motor mounting plate 822 in order to form an internal space receiving the spindle motor 100 and the head transfer part 810.

As set forth above, according to exemplary embodiments of the present disclosure, the spindle motor capable of suppressing evaporation of the lubricating fluid simultaneously with preventing leakage of the lubricating fluid may be provided.

In addition, the spindle motor having the structure capable of confirming the filled amount of the fluid as close as possible during the process of filling the lubricating fluid may be provided.

While exemplary embodiments have been shown and described above, it will be apparent to those skilled in the art that modifications and variations could be made without departing from the scope of the present invention as defined by the appended claims.

What is claimed is:

1. A spindle motor comprising:
a lower thrust member fixedly attached to a base member;
a shaft having a lower end portion coupled to the lower thrust member and an upper end portion provided with a flange part;
a rotating member including a sleeve rotatably provided based on the shaft and a rotor hub extended from the sleeve in an outer radial direction; and
a sealing member provided at an end portion of the flange part, extended in a downward axial direction so as to enclose an outer portion of an upper end of the sleeve, and forming a liquid-vapor interface between the sealing member and the sleeve,
wherein the sealing member has a first inclined surface inclined in an inner radial direction and downwardly in the axial direction.

2. The spindle motor of claim 1, wherein the rotor hub has a second inclined surface inclined so that a gap between the first inclined surface of the sealing member and a surface facing the first inclined surface is decreased inwardly in the radial direction.

3. The spindle motor of claim 2, wherein the second inclined surface is inclined so that a lowermost end portion of the sealing member is visible when viewing a gap between the sealing member and the rotor hub from the outside.

4. The spindle motor of claim 1, further comprising a cap member covering a gap formed by the sealing member and the rotor hub.

5. The spindle motor of claim 4, wherein the cap member includes a fixed part having an end portion fixed to an upper surface of the rotor hub, a cover part extended from the fixed part inwardly in the radial direction and bent toward an upper portion of the sealing member, and an extension part extended from an inner end of the cover part in a radial direction to the upper portion of the sealing member.

6. The spindle motor of claim 5, wherein the rotor hub includes a seating step part on which the fixed part is seated.

7. The spindle motor of claim 5, wherein the sealing member includes a sealing disposal part stepped so that an end portion of the extension part is disposed thereon.

8. The spindle motor of claim 1, wherein a portion of the sleeve facing the sealing member includes a portion inclined inwardly in the radial direction and downwardly in the axial direction.

9. The spindle motor of claim 1, wherein a portion of the sealing member facing the sleeve includes a portion inclined in the outer radial direction and downwardly in the axial direction.

10. A hard disk drive comprising:
the spindle motor of claim 1, rotating a disk by power applied thereto through a substrate;
a magnetic read-write head writing data to and reading data from the disk; and
a head transfer part transferring the magnetic read-write head to a predetermined position on the disk.
